(19) United States
(12) Patent Application Publication
(10) Pub. No.: US 2004/0083466 A1
(43) Pub. Date: Apr. 29, 2004

(54) Hardware parser accelerator

(76) Inventors: Michael C. Dapp, Endwell, NY (US); Eric C. Lett, Endwell, NY (US)

Correspondence Address: Whitham, Curtis & Christofferson, PC, Suite 340, 11491 Sunset Hills Road, Reston, VA, 20190, US

(21) Appl. No.: 10/331,315

(22) Filed: Dec. 31, 2002

Related U.S. Application Data
(60) Provisional application No. 60/421,775, filed on Oct. 29, 2002.

(51) Int. Cl. G06F 9/45

(52) U.S. Cl. 717/143; 717/142; 717/110

(57) ABSTRACT

Dedicated hardware is employed to perform parsing of documents such as XML™ documents in much reduced time while removing a substantial processing burden from the host CPU. The conventional use of a state table is divided into a character palette, a state table in abbreviated form, and a next state palette. The palettes may be implemented in dedicated high speed memory and a cache arrangement may be used to accelerate accesses to the abbreviated state table. Processing is performed in parallel pipelines which may be partially concurrent. dedicated registers may be updated in parallel as well and strings of special characters of arbitrary length accommodated by a character palette skip feature under control of a flag bit to further accelerate parsing of a document.

### CROSS-REFERENCE TO RELATED APPLICATIONS

This application claims benefit of priority of U.S. Provisional Patent Application S. No. 60/421,775, filed Oct. 29, 2002, the entire contents of which are hereby fully incorporated by reference. Further, this application is related to U.S. Patent Applications 10/______,______ and 10/______,______ (Docket numbers FS-00767 and FS-00768, corresponding to U.S. Provisional Patent applications 60/421,773 and 60/421,774, respectively) which are assigned to the assignee of this invention and also fully incorporated by reference herein.

### BACKGROUND OF THE INVENTION

1. Field of the Invention

The present invention generally relates to processing of applications for controlling the operations of general purpose computers and, more particularly, to performing parsing operations on applications programs, documents and/or other logical sequences of network data packets.

2. Description of the Prior Art

The field of digital communications between computers and the linking of computers into networks has developed rapidly in recent years, similar, in many ways to the proliferation of personal computers of a few years earlier. This increase in interconnectivity and the possibility of remote processing has greatly increased the effective capability and functionality of individual computers in such networked systems. Nevertheless, the variety of uses of individual computers and systems, preferences of their users and the state of the art when computers are placed into service has resulted in a substantial degree of variety of capabilities and configurations of individual machines and their operating systems, collectively referred to as “platforms” which are generally incompatible with each other to some degree particularly at the level of operating system and programming language.

This incompatibility of platform characteristics and the simultaneous requirement for the capability of communication and remote processing and a sufficient degree of compatibility to support it has resulted in the development of object oriented programming (which accommodates the concept of assembling an application as well as data as a group of more or less generalized modules through a referencing system of entities, attributes and relationships) and a number of programming languages to embody it. Extensible Markup Language™ (XML™) is such a language which has come into widespread use and can be transmitted as a document over a network of arbitrary construction and architecture.

In such a language, certain character strings correspond to certain commands or identifications, including special characters and other important data (collectively referred to as control words) which allow data or operations to, in effect, identify themselves so that they may be thereafter treated as “objects” such that associated data and commands can be translated into the appropriate formats and commands of different applications in different languages in order to engender a degree of compatibility of respective connected platforms sufficient to support the desired processing at a given machine. The detection of these character strings is performed by an operation known as parsing, similar to the more conventional usage of resolving the syntax of an expression, such as a sentence, into its component parts and describing them grammatically.

When parsing an XML™ document, a large portion and possibly a majority of the central processor unit (CPU) execution time is spent traversing the document searching for control words, special characters and other important data as defined for the particular XML™ standard being processed. This is typically done by software which queries each character and determines if it belongs to the predefined set of strings of interest, for example, a set of character strings comprising the following “<command>”, “<data=dataword>”, “<endcommand>”, etc. If any of the target strings are detected, a token is saved with a pointer to the location in the document for the start of the token and the length of the token. These tokens are accumulated until the entire document has been parsed.

The conventional approach is to implement a table-based finite state machine (FSM) in software to search for these strings of interest. The state table resides in memory and is designed to search for the specific patterns in the document. The current state is used as the base address into the state table and the ASCII representation of the input character is an index into the table. For example, assume the state machine is in state 0 (zero) and the first input character is ASCII value 02, the absolute address for the state entry would be the sum/concatenation of the base address (state 0) and the index/ASCII character (02). The FSM begins with the CPU fetching the first character of the input document from memory. The CPU then constructs the absolute address into the state table in memory corresponding to the initialized/current state and the input character and then fetches the state data from the state table. Based on the state data that is returned, the CPU updates the current state to the new value, if different (indicating that the character corresponds to the first character of a string of interest) and performs any other action indicated in the state data (e.g. issuing a token or an interrupt if the single character is a special character or if the current character is found, upon a further repetition of the foregoing, to be the last character of a string of interest).

The above process is repeated and the state is changed as successive characters of a string of interest are found. That is, if the initial character is of interest as being the initial character of a string of interest, the state of the FSM can be advanced to a new state (e.g. from initial state 0 to state 1). If the character is not of interest, the state machine would (generally) remain the same by specifying the same state (e.g. state 0) or not commanding a state update) in the state table entry that is returned from the state table address. Possible actions include, but are not limited to, setting interrupts, storing tokens and updating pointers. The process is then repeated with the following character. It should be noted that while a string of interest is being followed and the FSM is in a state other than state 0 (or other state indicating that a string of interest has not yet been found or currently being followed) a character may be found which is not consistent with a current string but is an initial character of another string of interest. In such a case, state table entries would indicate appropriate action to indicate and identify the string fragment or portion previously being followed and to follow the possible new string of interest until the new string is completely identified or found not to be a string of interest. In other words, strings of interest may be nested and the state machine must be able to detect a string of interest within another string of interest, and so on. This may require the CPU to traverse portions of the XML™ document numerous times to completely parse the XML™ document.

The entire XML™ or other language document is parsed character-by-character in the above-described manner. As potential target strings are recognized, the FSM steps through various states character-by-character until a string of interest is fully identified or a character inconsistent with a possible string of interest is encountered (e.g. when the string is completed/fully matched or a character deviates from a target string). In the latter case, no action is generally taken other than returning to the initial state or a state corresponding to the detection of an initial character of another target string. In the former case, the token is stored into memory along with the starting address in the input document and the length of the token. When the parsing is completed, all objects will have been identified and processing in accordance with the local or given platform can be started.

Since the search is generally conducted for multiple strings of interest, the state table can provide multiple transitions from any given state. This approach allows the current character to be analyzed for multiple target strings at the same time while conveniently accommodating nested strings.

It can be seen from the foregoing that the parsing of a document such as an XML™ document requires many repetitions and many memory accesses for each repetition. Therefore, processing time on a general purpose CPU is necessarily substantial. A further major complexity of handling the multiple strings lies in the generation of the large state tables and is handled off-line from the real-time packet processing. However, this requires a large number of CPU cycles to fetch the input character data, fetch the state data and update the various pointers and state addresses for each character in the document. Thus, it is relatively common for the parsing of a document such as an XML™ document to fully pre-empt other processing on the CPU or platform and to substantially delay the processing requested.

It has been recognized in the art that, through programming, general-purpose hardware can be made to emulate the function of special purpose hardware and that special purpose data processing hardware will often function more rapidly than programmed general purpose hardware even if the structure and program precisely correspond to each other since there is less overhead involved in managing and controlling special purpose hardware. Nevertheless, the hardware resources required for certain processing may be prohibitively large for special purpose hardware, particularly where the processing speed gain may be marginal. Further, special purpose hardware necessarily has functional limitations and providing sufficient flexibility for certain applications such as providing the capability of searching for an arbitrary number of arbitrary combinations of characters may also be prohibitive. Thus, to be feasible, special purpose hardware must provide a large gain in processing speed while providing very substantial hardware economy; requirements which are increasingly difficult to accommodate simultaneously as increasing amounts of functional flexibility or programmability are needed in the processing function required.

In this regard, the issue of system security is also raised by both interconnectability and the amount of processing time required for parsing a document such as an XML™ document. On the one hand, any process which requires an extreme amount of processing time at relatively high priority is, in some ways, similar to some characteristics of a denial-of-service (DOS) attack on the system or a node thereof or can be a tool that can be used in such an attack.

DOS attacks frequently present frivolous or malformed requests for service to a system for the purpose of maliciously consuming and eventually overloading available resources. Proper configuration of hardware accelerators can greatly reduce or eliminate the potential for overloading of available resources. In addition, systems often fail or expose security weaknesses when overloaded. Thus, eliminating overloads is an important security consideration.

Further, it is possible for some processing to begin and some commands to be executed before parsing is completed since the state table must be able to contain CPU commands at basic levels which are difficult or impossible to secure without severe compromise of system performance. In short, the potential for compromise of security is necessarily reduced by reduction of processing time for processes such as XML™ parsing.

### SUMMARY OF THE INVENTION

The invention provides a dedicated processor and associated hardware for accelerating the parsing process for documents such as XML™ documents while limiting the amount of hardware and memory required.

In order to accomplish these and other capabilities of the invention, a hardware parser accelerator is provided including a document memory, a character pallette containing addresses corresponding to characters in the document, a state table containing a plurality of entries corresponding to a character, a next state pallette including a state address or offset, and a token buffer, wherein entries in said state table include at least one of an address into said next state pallette and a token.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a representation of a portion of a state table used in parsing a document,

FIG. 2 is a high level schematic diagram of the parser accelerator in accordance with the invention,

FIG. 3 illustrates a preferred character palette format as depicted in FIG. 2,

FIGS. 4A and 4B illustrate a state table format and a state table control register used in conjunction therewith in a preferred form of the invention as depicted in FIG. 2,

FIG. 5 illustrates a preferred next state palette format as depicted in FIG. 2, and

FIG. 6 is a preferred token format as depicted in FIG. 5.

### DETAILED DESCRIPTION OF A PREFERRED EMBODIMENT OF THE INVENTION

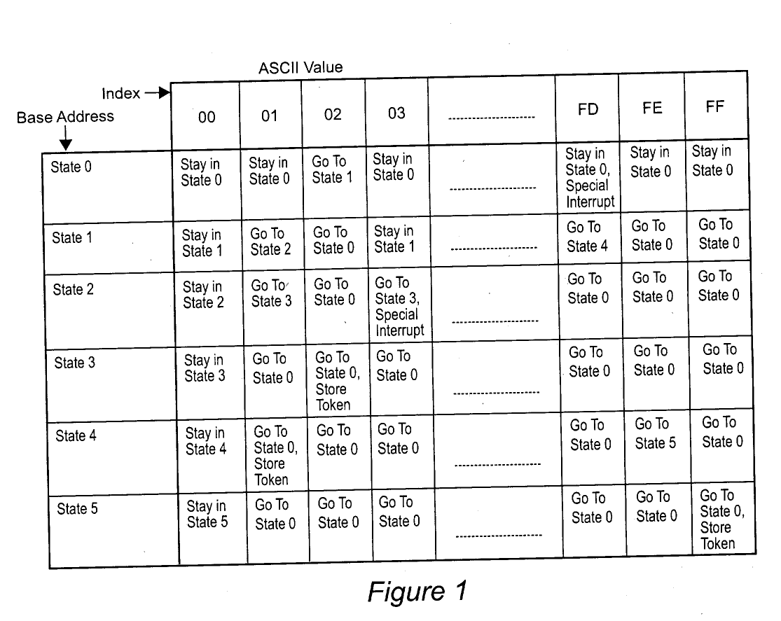

Referring now to the drawings, and more particularly to FIG. 1, there is shown a representation of a portion of a state table useful in understanding the invention. It should be understood that the state table shown in FIG. 1 is potentially only a very small portion of a state table useful for parsing an XML™ document and is intended to be exemplary in nature. It should be noted that an XML™ document is used herein as an example of one type of logical data sequence which can be processed using an accelerator in accordance with the invention. Other logical data sequences can also be constructed from network data packet contents such as user terminal command strings intended for execution by shared server computers. While the full state table does not physically exist, at least in the form shown, in the invention and FIG. 1 can also be used in facilitating an understanding of the operation of known software parsers, no portion of FIG. 1 is admitted to be prior art in regard to the present invention.

It will also be helpful observe that many entries in the portion of the state table illustrated in FIG. 1 are duplicative and it is important to an appreciation of the invention that hardware to accommodate the entirety of the state table represented by FIG. 1 is not required. Conversely, while the invention can be implemented in software, possibly using a dedicated processor, the hardware requirements in accordance with the invention are sufficiently limited that the penalty in increased processing time for parsing by software is not justified by any possible economy in hardware.

In FIG. 1 the state table is divided into an arbitrary number of rows, each having a base address corresponding to a state. The rows of the base address are divided into a number of columns corresponding to the number of codes which may be used to represent characters in the document to be parsed; in this example, two hundred fifty-six (256) columns corresponding to a basic eight bit byte for a character which is used as an index into the state table.

It will be helpful to note several aspects of the state table entries shown, particularly in conveying an understanding of how even the small portion of the exemplary state table illustrated in FIG. 1 supports the detection of many words:

1. In the state table shown, only two entries in the row for state 0 include an entry other than “stay in state 0” which maintains the initial state when the character being tested does not match the initial character of any string of interest. The single entry which provides for progress to state 1 corresponds to a special case where all strings of interest begin with the same character. Any other character that would provide progress to another state would generally but not necessary progress to a state other than state 1 but a further reference to the same state that could be reached through another character may be useful to, for example, detect nested strings. The inclusion of a command (e.g. “special interrupt”) with “stay in state 0” illustrated at {state 0, FD} would be used to detect and operate on special single characters.

2. In states above state 0, an entry of “stay in state n” provides for the state to be maintained through potentially long runs of one or more characters such as might be encountered, for example, in numerical arguments of commands, as is commonly encountered. The invention provides special handling of this type of character string to provide enhanced acceleration, as will be discussed in detail below.

3. In states above state 0, an entry of “go to state 0” signifies detection of a character which distinguishes the string from any string of interest, regardless of how many matching characters have previously been detected and returns the parsing process to the initial/default state to begin searching for another string of interest. (For this reason, the “go to state 0” entry will generally be, by far, the most frequent or numerous entry in the state table.) Returning to state 0 may require the parsing operation to return to a character in the document subsequent to the character which began the string being followed at the time the distinguishing character was detected.

4. An entry including a command with “go to state 0 indicates completion of detection of a complete string of interest. In general, the command will be to store a token (with an address and length of the token) which thereafter allows the string to be treated as an object. However, a command with “go to state n” provides for launching of an operation at an intermediate point while continuing to follow a string which could potentially match a string of interest.

5. To avoid ambiguity at any point where the search branches between two strings of interest (e.g. strings having n−1 identical initial characters but different n-th characters, or different initial characters), it is generally necessary to proceed to different (e.g. non-consecutive) states, as illustrated at {state 1, 01} and {state1, FD}. Complete identification of a string of arbitrary length n will require n−1 states except for the special circumstances of included strings of special characters and strings of interest which have common initial characters. For these reason, the number of states and rows of the state table must usually be extremely large, even for relatively modest numbers of strings of interest.

7. Conversely to the previous paragraph, most states can be fully characterized by one or two unique entries and a default “go to state 0”. This feature of the state table of FIG. 1 is exploited in the invention to produce a high degree of hardware economy and substantial acceleration of the parsing process for the general case of strings of interest.

As alluded to above, the parsing operation, as conventionally performed, begins with the system in a given default/initial state, depicted in FIG. 1 as state 0, and then progresses to higher numbered states as matching characters are found upon repetitions of the process. When a string of interest has been completely identified or when a special operation is specified at an intermediate location in a string which is potentially a match, the operation such as storing a token or issuing an interrupt is performed. At each repetition for each character of the document, however, the character must be fetched from CPU memory, the state table entry must be fetched (again from CPU memory) and various pointers (e.g. to a character of the document and base address in the state table) and registers (e.g. to the initial matched character address and an accumulated length of the string) must be updated in sequential operations. Therefore, it can be readily appreciated that the parsing operation can consume large amounts of processing time.

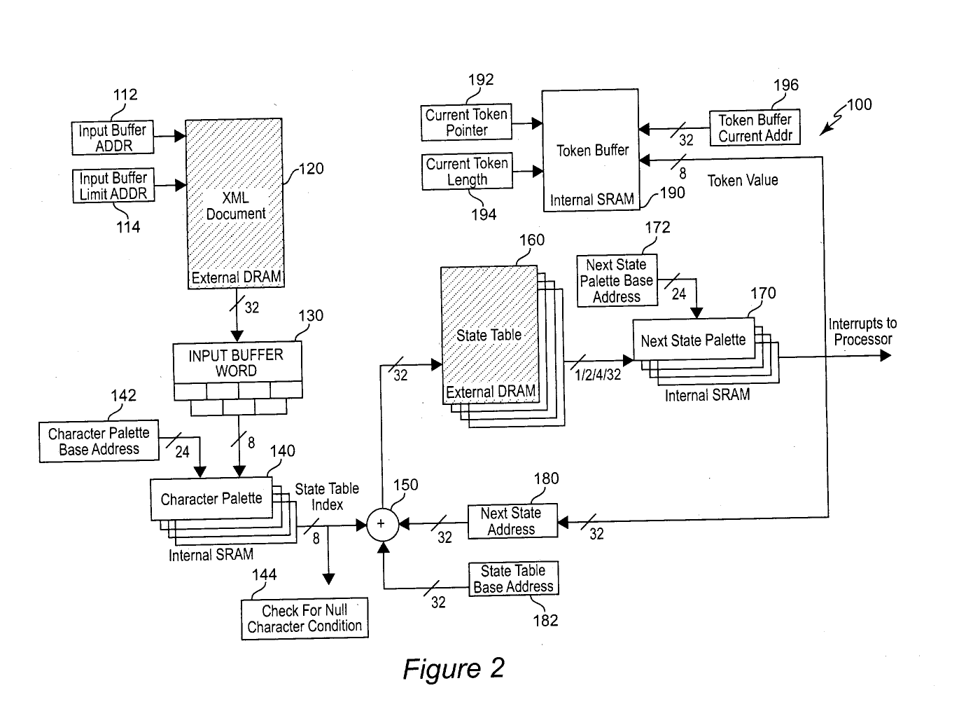

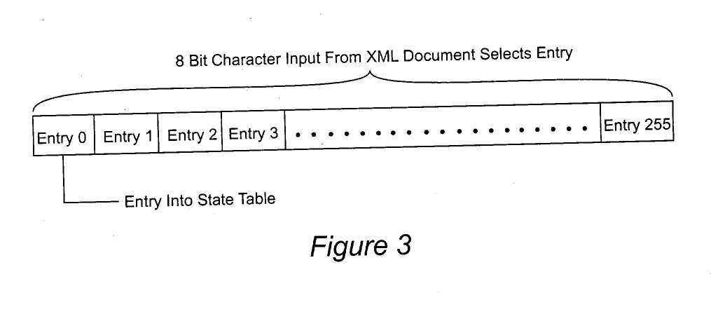

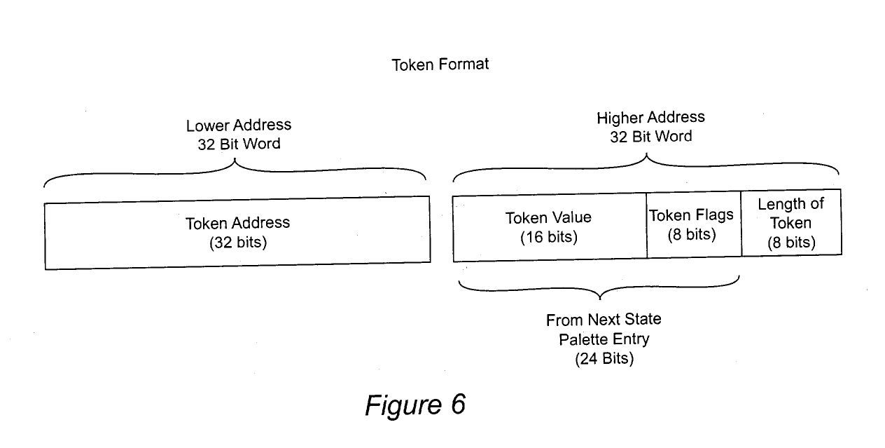

A high-level schematic block diagram of the parser accelerator 100 in accordance with the invention is illustrated in FIG. 2. As will be appreciated by those skilled in the art, FIG. 2 can also be understood as a flow diagram illustrating the steps performed in accordance with the invention to perform parsing. As will be discussed in greater detail below in connection with FIGS. 3, 4A, 4B, 5 and 6, the invention exploits some hardware economies in representing the state table such that a plurality of hardware pipelines are developed which operate essentially in parallel although slightly skewed in time. Thus, the updating of pointers and registers can be performed substantially in parallel and concurrently with other operations while the time required for memory accesses is much reduced through both faster access hardware operated in parallel and prefetching from CPU memory in regard to the state table and the document.

As a general overview, the document such as an XML™ document is stored externally in DRAM 120 which is indexed by registers 112, 114 and transferred by, preferably, thirty-two bit words to and input buffer 130 which serves as a multiplexer for the pipelines. Each pipeline includes a copy of a character palette 140, state table 160 and a next state palette 170; each accommodating a compressed form of part of the state table. The output of the next state palette 170 contains both the next state address portion of the address into entries in the state table 160 and the token value to be stored, if any. Operations in the character palette 140 and the next state palette 170 are simple memory accesses into high speed internal SRAM which may be performed in parallel with each other as well as in parallel with simple memory accesses into the high speed external DRAM forming the state table 160 (which may also be implemented as a cache). Therefore, only a relatively few clock cycles of the CPU initially controlling these hardware elements (but which, once started, can function autonomously with only occasional CPU memory operation calls to refresh the document data and to store tokens) are required for an evaluation of each character in the document. The basic acceleration gain is the reduction of the sum of all memory operation durations per character in the CPU plus the CPU overhead to the duration of a single autonomously performed memory operation in high-speed SRAM or DRAM.

It should be understood that memory structures referred to herein as “external” is intended to connote a configuration of memories 120, 140, which is preferred by the inventors at the present time in view of the amount of storage required and access from the hardware parser accelerator and/or the host CPU. In other words, it may be advantageous for handling of tokens and some other operations to provide an architecture of the parser accelerator in accordance with the invention to facilitate sharing of the memory or at least access to the memory by the host CPU as well as the hardware accelerator. No other connotation intended and a wide variety of hardware alternatives such as synchronous DRAM (SDRAM) will be recognized as suitable by those skilled in the art in view of this discussion.

Referring now to FIGS. 3-6, the formats of the character palette 140, the state table 160, next state palette 170 and next state and token will be discussed as exemplary of the hardware economies which support the preferred implementation of FIG. 2. Other techniques/formats can be employed, as well, and the illustrated formats should be understood as exemplary although currently preferred.

FIG. 3 illustrates the preferred form of a character palette which corresponds to the characters which are or may be included in the strings of interest. This format preferably provides entries numbered 0-255, corresponding to the number of columns in the state table of FIG. 1. (The term “palette” is used in much the same sense as in the term “color palette” containing data for each color supported and collectively referred to as a gamut. Use of a pallette reduces entries/columns in the state table.) For example, a character referred to as a “null character” which does not result in a change of state can be expressed in one column of the state table rather than many such columns. It is desirable to test for a null character output at 144 which can substantially accelerate processing for parsing since it allows immediate processing of the next character without a further memory operation for state table access. The format can be accommodated by a single register or memory locations configured as such by, for example, data in base address register 142 which points to a particular character palette (schematically illustrated by overlapping memory planes in FIG. 2). The current eight bit character from the document (e.g. XML™ document), one of four provided from the input buffer 130 as received as a four byte word from the external DRAM 120, addresses an entry in the character palette which then outputs an address as an index or partial pointer into the state memory. Thus by providing a palette in such a format a portion of the functionality of FIG. 1 can be provided in the form of a single register of relatively limited capacity; thus allowing a plurality thereof to be formed and operated in parallel while maintaining substantial hardware economy and supporting others in the state table 160.

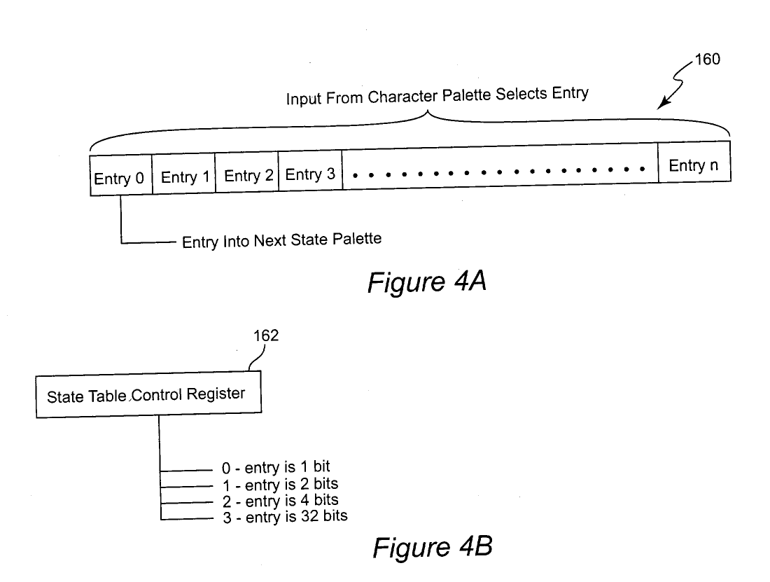

FIG. 4A shows the preferred state table format which is constituted or configured similarly to the character palette (e.g. substantially as a register). The principal difference from the character palette of FIG. 3 is that the length of the register is dependent on the number of responses to characters desired and the number and length of strings of interest. Therefore, it is considered desirable to provide for the possibility of implementing this memory in CPU or other external DRAM (possibly with an internal or external cache) if the amount of internal memory which can be economically provided is insufficient in particular instances. Nevertheless, it is clear that a substantial hardware economy is provided since highly duplicative entries in the state table of FIG. 1 can be reduced to a single entry; the address of which is accommodated by the data provided as described above in accordance with the character palette of FIG. 3. The output of the state table 160 is preferably one, two or four bits but provision for as much as thirty-two bits may provide increased flexibility, as will be discussed below in connection with FIG. 4B. In any case, the output of the state table provides an address or pointer into the next state palette 170.

Referring now to FIG. 4B, as a perfecting feature of the invention in this latter regard, a preferred implementation feature of the invention includes a state table control register 162 which allows a further substantial hardware economy, particularly if a thirty-two bit output of state table 160 is to be provided. Essentially, the state table control register provides for compression of the state table information by allowing a variable length word to be stored in and read out of the state table.

More specifically, the state table control register 162 stores and provides the length of each entry in the state table 160 of FIG. 4A. Since some state table entries in FIG. 1 are highly duplicative (e.g. “go to state 0”, “stay in state n”, these entries not only can be represented by a single entry in state table 160 or at least much fewer than in FIG. 1 but may also be represented by fewer bits, possibly as few as one which will yield substantial hardware economies even if most or all duplicative entries are included in the state table, as may be found convenient in some state tables. The principle of this reduction will be recognized by those skilled in the art as similar to so-called entropy coding.

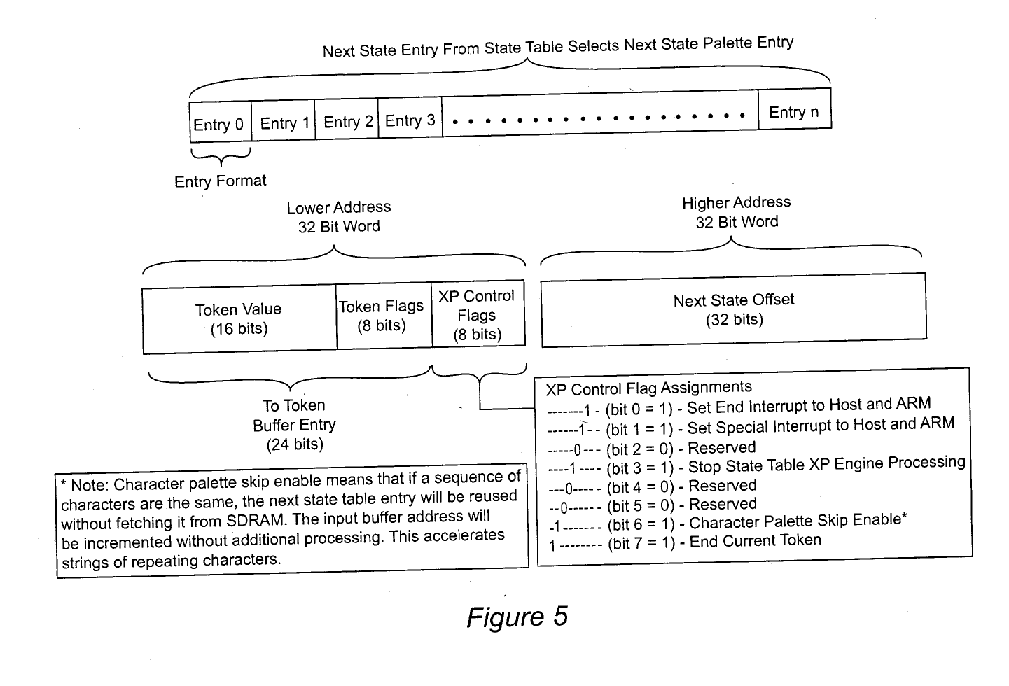

Referring now to FIG. 5, the preferred format of the next state palette 170 will now be discussed. The next state pallette 170 is preferably implemented in much the same manner as the character palette 140 discussed above. However, as with the state memory 160, the number of entries that may be required is not, a priori, known and the length of individual entries is preferably much longer (e.g. two thirty-two bit words). On the other hand, the next state palette 170 can be operated as a cache (e.g. using next state palette base address register 172) since only relatively small and predictable ranges of addresses need be contained at any given time. Further, if thirty-two bit outputs of the state table 160 is provided, some of that data can be used to supplement the data in entries of the next state palette 170, possibly allowing shorter entries in the latter or possibly bypassing the next state pallette altogether, as indicated by dashed line 175.

As shown in FIG. 5, the lower address thirty-two bit word output from the next state palette 170 is the token to be saved. This token preferably is formed as a token value of sixteen bits, eight bits of token flags, both of which are stored in token buffer 190 at an address provided by pointer 192 to the beginning of the string and together with the length accumulated by counting successful character comparisons, and eight bits of control flags. The control flags set interrupts to the host CPU or control processing in the parser accelerator. One of these latter control flags is preferably used to set a skip enable function for characters which do not cause a change of state at a state other than state 0 such as a string of the same or related characters of arbitrary length which may occur in a string of interest, as alluded to above. In such a case, the next state table entry can be reused without fetching it from SRAM/SDRAM. The input buffer address 112 is incremented without additional processing; allowing substantial addition acceleration of parsing for certain strings of characters. The second thirty-two bit word is an address offset fed back to register 180 and adder 150 to be concatenated with the index output from the character palette to form a pointer into the state table for the next character. The initial address corresponding to state 0 is supplied by register 182.

Thus, it is seen that the use of a character palette, a state memory in an abbreviated form and a next state memory articulate the function of the conventional state memory operations into separate stages; each of which can be performed extremely rapidly with relatively little high speed memory which can thus be duplicated to form parallel pipelines operating on respective characters of a document in turn and in parallel with other operations and storage of tokens. Therefore, the parsing process can be greatly accelerated relative to even a dedicated processor which must perform all of these functions in sequence before processing of another character can be started.

In summary, the accelerator has access to the program memory of the host CPU where the character data (sometimes referred to as packet data connoting transmission of a network) and state table are located. The accelerator 100 is under control of the main CPU via memory-mapped registers. The accelerator can interrupt the main CPU to indicate exceptions, alarms and terminations. When parsing is to be started, pointers (112, 114) are set to the beginning an end of the input buffer 130 data to be analyzed, the state table to be used (as indicated by base address 182 and other control information (e.g. 142) is set up within the accelerator.

To initiate operation of the accelerator, the CPU issues a command to the accelerator which, in response, fetches a first thirty-two bit word of data from the CPU program memory (e.g. 120 or a cache) and places it into the input buffer 130 from which the first byte/ASCII character is selected. The accelerator fetches the state information corresponding to the input character (i.e. FIG. 4A corresponds to a single character or a single column of the full state table of FIG. 1) and the current state. The state information includes the next state,address and any special actions to be performed such as interrupting the CPU or terminating the processing. The advancing of the state information thus supports detection not only of single strings of interest but also nested strings, alluded to above, and sequences of strings or corresponding tokens such as words or phrases of text in a document. The interrupts and or exceptions which can be issued in response thereto are not limited to internal control of the parser and the issuance of tokens but may generate alerts or other initiate other processing to provide other functions such as intercepting unwanted electronic mail or blocking objectionable subject matter or content-based routing, possibly through issuance of special tokens for.

The accelerator next selects the next byte to be analyzed from input buffer 130 and repeats the process with the new state information which will already be available to adder 150. The operation or token information storage can be performed concurrently. This continues until all four characters of the input word have been analyzed. Then (or concurrently with the analysis of the fourth character by prefetching) buffers 112, 114 are compared to determine if the end of the document buffer 120 is reached and, if so, an interrupt is sent back to the CPU. If not, a new word is fetched, the buffer 112 is updated and the processing is repeated.

Since the pointers and counters are implemented in dedicated hardware they can be updated in parallel rather than serially as would be required if implemented in software. This reduces the time to analyze a byte of data to the time required to fetch the character from a local input buffer, generate the state table address from high speed local character palette memory, fetch the corresponding state table entry from memory and to fetch the next state information, again from local high speed memory. Some of these operations can be performed concurrently in separate parallel pipelines and other operations specified in the state table information (partially or entirely provided through the next state palette) may be carried out while analysis of further characters continues.

Thus, it is clearly seen that the invention provides substantial acceleration of the parsing process through a small and economical amount of dedicated hardware. While the parser accelerator can interrupt the CPU, the processing operation is entirely removed therefrom after the initial command to the parser accelerator.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A parser accelerator including
a document memory,
a character pallette containing addresses corresponding to characters in said document,
a state table containing a plurality of entries corresponding to a said character,
a next state pallette including a state address or offset, and
a token buffer, wherein
said entries in said state table include at least one of an address into said next state pallette and a token.

2. The parser accelerator as recited in claim 1 wherein said character pallette, said state table and said next state pallette form a pipeline.

3. The parser accelerator as recited in claim 2, wherein each of said character pallette, said state table and said next state pallette each contain a respective portion of state table information in compressed form.

4. The parser accelerator as recited in claim 1, wherein the next state palette contains the next state address portion of the address into entries in said state table and a token value to be stored.

5. The parser accelerator as recited in claim 1, further including
means for detecting a character in a string which does not result in a change of state.

6. The parser accelerator as recited in claim 5, further including
means for immediate processing of the next character without a further memory operation for state table access.

7. The parser accelerator as recited in claim 2, wherein said pipeline is implemented in hardware.

8. The parser accelerator of claim 2, wherein said pipeline forms a loop including means for combining a next state address with a state table index from said character pallette.

9. A method of parsing an electronic file for identifying strings of interest, said method including steps of
storing respective portions of state table information in a character pallette, a state table and a next state pallette forming a looped pipeline to detect portions of said 'string of interest,
obtaining token information from said state table, and
storing said token information in parallel with said detecting of portions of said string of interest.

10. A method as recited in claim 9, including the further step of
detecting sequences of strings of interest, and
issuing a special token responsive to said step of detecting sequences for controlling processing.

11. A method as recited in claim 10, wherein a said sequence of strings of interest includes a nested string.

12. A method as recited in claim 10, wherein a said sequence of strings of interest correspond to words or phrases of text in a document.

13. A method as recited in claim 10, wherein said further processing performs blocking of a message.

14. A method as recited in claim 10, wherein said further processing performs content based routing.
